(19) United States
(12) Patent Application Publication
(10) Pub. No.: US 2008/0087521 A1
(43) Pub. Date: Apr. 17, 2008

(54) Gaming device with a vertically translating currency acceptor

(76) Inventor: Joseph W. Cole, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/582,771

(22) Filed: Oct. 17, 2006

(51) Int. Cl. G07F 9/10

(52) U.S. Cl. 194/350

(57) ABSTRACT

A gaming device is disclosed that provides a convenient way to access a currency container. The currency container may be accessed by raising the currency acceptor in a substantially vertical direction above the playing surface with respect to the top of the gaming device. An independent and lockable access panel is provided that allows only authorized personnel to access and raise the currency acceptor. A latch mechanism and biasing member are provided for releasing and raising a currency acceptor carriage which contains the currency acceptor and currency container to a raised position. The carriage may be returned to a lower position by either compressing or reversing the biasing member and re-engaging the latch mechanism. The gaming device is then restored to pre-collection configuration by closing and securely retaining the access panel.

### FIELD OF THE INVENTION

The present invention relates to wagering-type gaming devices. More specifically, the present invention relates to a currency acceptor for a gaming device.

### BACKGROUND OF THE INVENTION

Gaming devices have become extremely popular in recent times and are commonly the primary attraction for many gaming and entertainment establishments. These gaming devices may have several physical configurations such as an upright, a slant-top or a table-top construction. Each of these various configurations provides a player with a different orientation in which to play the gaming device. An upright gaming device is considered a traditional configuration and basically provides a gaming device that has a vertical layout that is tall and narrow.

A slant-top gaming device is a fairly recent design enhancement that provides a gaming device that is ergonomically adapted for seated game play. In this configuration, the internal components of the gaming device are condensed into a low-profile that is shorter and wider than the traditional upright configuration. The slant-top configuration typically has a game display area that is inclined at a convenient viewing angle for the player.

A table-top configuration is similar to the slant-top in that the gaming device is adapted for seated play. However, a table-top gaming device has a game display area that is considerably flush with the surrounding table or bar top area. This gaming device configuration is specially adapted for mounting within a table or bar top. Gaming establishments will commonly employ many of these configurations to suit their particular interior design requirements. Each of these different gaming device configurations has particular advantages and disadvantages. Therefore, the particular design of each gaming device must be independently considered.

It is common for modern gaming devices, regardless of physical configuration, to accept coins and paper currency. In a popular gaming establishment, the gaming devices require frequent collection of currency stored within the machine. Gaming establishments will collect the currency in order to prevent the gaming device from becoming full and before the gaming device is no longer able to accept additional wagers from players. Additionally the gaming establishment will frequently collect currency stored within the gaming device for security, processing and accounting purposes.

For example, wagering type gaming devices typically accept paper and coin currency from players. The gaming devices thus generally have a coin storage area, commonly referred to as a coin hopper, and a paper currency storage area. Paper currency is usually inserted into a gaming device by way of a bill acceptor unit that is operatively installed within the gaming device. A bill acceptor will usually have a dedicated storage area that is specifically adapted to accept and store paper currency. The paper currency storage area is commonly configured to stack the paper currency in a removable container. The removable container is usually referred to as a cash box. When collecting paper currency, a technician will collect the paper currency from the gaming device by removing the full cash box and installing an empty cash box.

The currency is commonly collected by opening the gaming device housing or cabinet to access and then remove the cash box. This process has a number of disadvantages. First, this process often results in access to or exposure of various sensitive equipment within the gaming device, such as the gaming device controller. Further, access to the cash box may be difficult. In an upright configuration, access to the interior of the gaming machine is conveniently provided through a large door which forms the front of the machine. On the other hand, access to the interior of a slant-top or table-top gaming device is typically through an access panel. However, in these low profile constructions, the access panel is typically below the playing surface of the machine. This often has a number of associated problems. First, the panel is often small and difficult to reach. In the case of a bar-top device, the panel may be between the front panel of a bar and adjacent bar stools, and underneath a overhanging bar-top surface. As such, a technician may need a great deal of time to access the cash box, thereby impacting play time and revenue, and also may require that players around the gaming machine which is being serviced move to provide sufficient access, again contributing to a decrease in play time.

An improved gaming device currency acceptor configuration is desired that facilitates currency collection, particularly with regard to paper currency collected from either a slant-top or table-top gaming device.

### SUMMARY OF THE INVENTION

The present invention is a vertically translating currency acceptor and methods of using and fabricating a gaming device with a vertically translating currency acceptor.

In one embodiment, the invention comprises a gaming cabinet that has a generally planar top and an interior space formed thereunder. A currency acceptor access panel is located at the top of the gaming cabinet. The currency acceptor access panel is configured to move between an open position and a closed position. The access panel when in the open position defines an access opening into the gaming cabinet. Located under the access panel is a currency acceptor carriage that houses or supports a currency acceptor. There is at least one linear transport having a first portion connected to the gaming cabinet and a second portion connected to the carriage. The linear transport is oriented so that the first and second portions may move relative to one another along a substantially vertical path. The carriage which is connected to the linear transport may be moved between a retracted position in which it is located in the interior space of the gaming cabinet and a raised position in which at least a portion of the carriage extends through the access opening when the currency acceptor panel is in the open position.

There is at least one biasing member operatively connected to the carriage or transport. The biasing member applies a biasing force tending to lift the carriage to the raised position. A latch mechanism is movable between a latched position in which it engages the carriage and maintains the carriage in the retracted position, and a released position in which the carriage is permitted to move upwardly to its raised position.

In one embodiment, there is a currency acceptor mounted to the carriage for vertical displacement in conjunction with the carriage. Additionally, the currency access panel may be securely lockable with respect to the top of the gaming cabinet.

Preferably, the vertically translating currency acceptor includes a biasing member that is a gas charged shock. In one embodiment, the biasing member and/or latch mechanism maybe an electro-mechanical device.

In another embodiment, the currency acceptor further includes a currency container located below the currency acceptor, where the currency container stores currency therein. Additionally, the currency acceptor carriage may include a currency storage panel for securely retaining a currency container located within the carriage.

In another embodiment of the invention, there is provided a method for accessing a currency container located within a table-top gaming device. In accordance with the method, the currency acceptor access panel is unlocked and opened to provide access to a currency acceptor and/or currency container located beneath the panel. By actuating and disengaging the latch mechanism, a carriage containing the currency acceptor and the currency container is raised upwardly to a raised position above a top surface of the gaming device. The currency container may then be removed from the carriage/currency acceptor assembly. A substantially empty currency container is then installed within the carriage/currency acceptor assembly. The carriage is then lowered to a retracted position within the gaming device and may be retained by way of the latch mechanism. Finally, the currency acceptor access panel is closed and locked in place.

In another embodiment, there is provided a method for fabricating a table-top gaming device with a vertically accessible currency acceptor.

For a fuller understanding of the nature and advantages of the present invention over the prior art, reference should be made to the ensuing detailed description and claims, taken in conjunction with the accompanying drawings.

### DESCRIPTION OF THE DRAWINGS

FIG. 1 is a perspective view of a gaming device in accordance with one embodiment of the present invention where a currency acceptor access panel thereof is illustrated in a first closed position;

FIG. 2 illustrates a perspective view of the gaming device with the currency acceptor access panel shown in a second open position;

FIG. 3 is a perspective view of a gaming device illustrating the actuation of a release mechanism or latch;

FIG. 4 illustrates a perspective view of the gaming device illustrated in FIG. 2, with a currency acceptor and currency container thereof shown in a second raised position;

FIG. 5 is an elevation view of a gaming device, with a side panel removed, illustrating a currency acceptor carriage and transport; and

FIG. 6 is a perspective view of a currency carriage, illustrating the removal of a currency container associated therewith.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have been indicated but not described in detail so as not to obscure the invention.

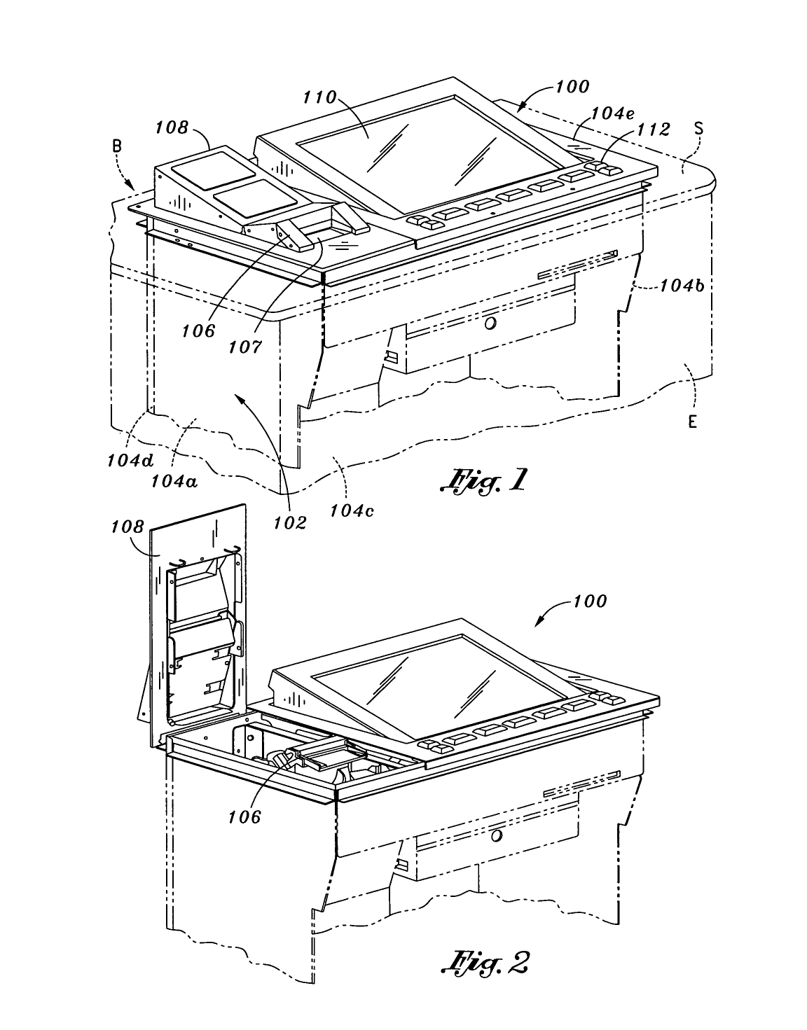

Referring to the figures, FIG. 1 illustrates a table or “bar”-top gaming device 100. As illustrated, the bar-top gaming device 100 is associated with a bar B.

In general, the gaming device 100 comprises a housing or cabinet 102 for supporting and/or enclosing various components of the gaming device. In one embodiment, the cabinet 102 has a first side 104a, an opposing second side 104b, a front 104c and an opposing back 104d. In this configuration, the peripheral shape of the cabinet 102 is generally quadrilateral. As illustrated, the cabinet 102 is generally rectangular.

In addition, the cabinet 102 includes a top 104e and an opposing bottom (not visible). In one configuration, one or more portions of the top 104e are configured as a door, thereby permitting access to a generally enclosed interior area of the cabinet 102 defined by the sides 104a,b,c,d and bottom.

The gaming device 100 preferably includes at least one display device 110. In one embodiment, the display device 110 is mounted to the top 104e of the cabinet 102. In other embodiments, the display device 110 may be mounted so as to simply be viewed through an opening or window in the top 104e. As illustrated, the display device 110 comprises an electronic video display. The display device 110 could comprise video displays of various types (LCD, CRT, LED, plasma, etc.) or be rotating reels, a wheel or other element for displaying game information to a player. The gaming device 100 may also include more than one display device (such as two or more video displays or multiple rotating reels).

The gaming device 100 also preferably includes one or more player input devices. As illustrated, such devices may comprise one or more buttons 112. Of course, other input devices (such as a touch-screen display, joystick, touch-pad or the like) may be utilized. As illustrated, the buttons 112 are associated with the top 104e of the housing 102.

In a preferred configuration, the gaming device 100 is mounted to the bar B or similar member. As illustrated, the bar B includes an enclosure E having a top surface S. The gaming device 100 is mounted so that the housing or cabinet 102 is generally located within the enclosure E of the bar B. So mounted, the top 104e of the gaming device 100 is located at the top surface S of the bar B. Thus, the cabinet 102 is generally inaccessible to the player, while the top 104e, including the player input devices 112 and display 110, are visible and accessible to the player.

The gaming device 100 is preferably configured to present one or more wagering games. A player may be required to place a wager to play the one or more games. In one embodiment, the gaming device 100 includes a currency acceptor 106 for accepting currency from a player for use as a wager.

The currency acceptor 106 may be of a variety of types now known or later developed. Such devices are available from a number of sources, including JCM America. In general, the currently acceptor 106 comprises a device for reading/scanning currency which is provided to it, in order to verify the authenticity of the currency. Normally, the currency is inserted through a slot 107 into the scanning device. Currency (or counterfeit currency) which is rejected is ejected back out the slot. Accepted currency is routed for storage in a currency container.

In the configuration illustrated, the currency acceptor 106, including the currency container, is mounted for movement into an out of the cabinet 102 of the gaming device 100. FIG. 1 illustrates the currency acceptor 106 in a retracted position in which it is located within the cabinet 102 of the gaming device 100. In this position, the currency acceptor 106 is preferably located under a currency acceptor access panel 108. This panel 108, which is associated with the top 104e of the cabinet 102 of the gaming device 100, preferably controls access to the currency acceptor 106.

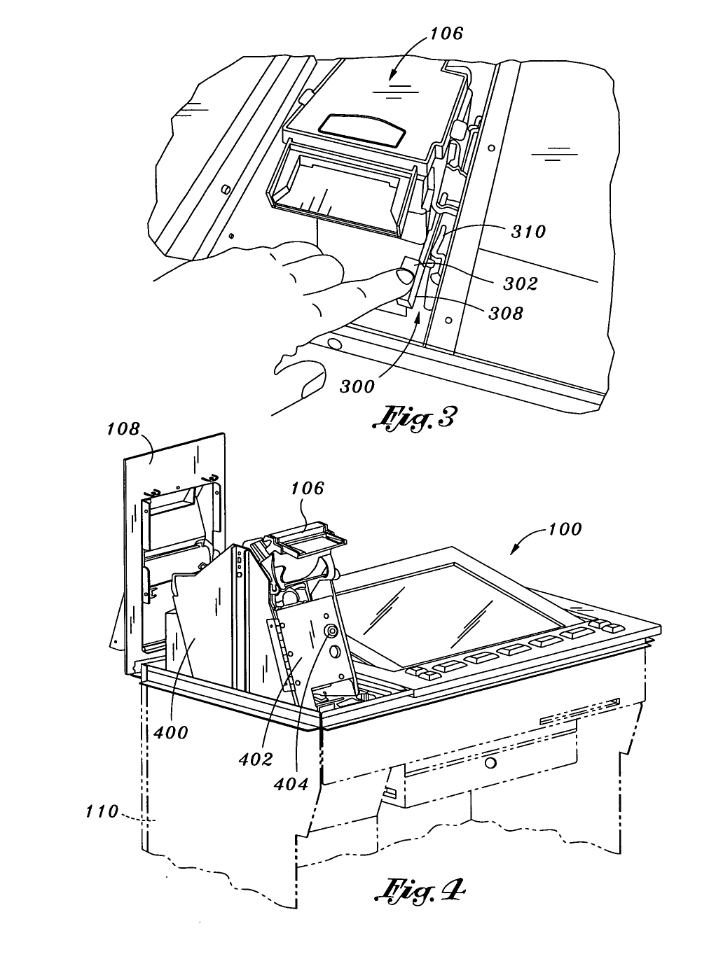

Preferably, the currency acceptor access panel 108 is movable from the closed position (as illustrated in FIG. 1) to an open position, as illustrated in FIG. 2. In particular, in one embodiment, the currency acceptor access panel 108 is hinged such that it may rotate to provide access to the currency acceptor 106. The currency acceptor access panel 108 may be mounted to the gaming device 100 in other fashions which permits movement between closed and open positions.

In one embodiment, a locking mechanism (not shown) may be utilized to selectively lock the access panel 108 in its closed position to prevent unauthorized access to the currency acceptor 106. The locking mechanism may be key-actuated or of other types.

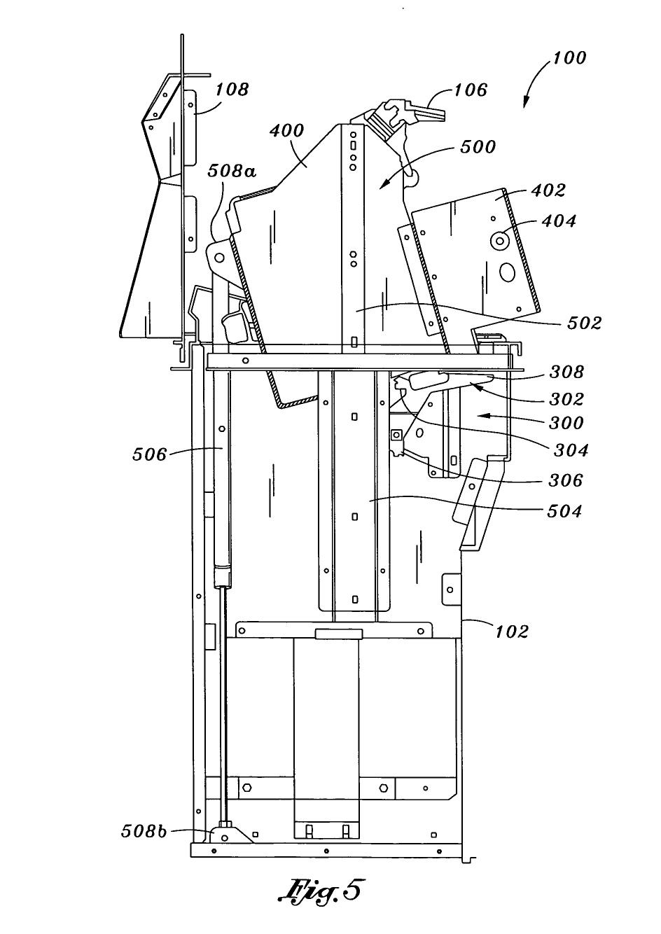

Most importantly, the currency acceptor 106 is configured to be moved from its retracted position (as illustrated in FIGS. 1 and 2), to an extended position, as illustrated in FIG. 4. In its extended position, the currency acceptor 106 preferably extends outwardly of the gaming device 100 to permit access to the various components of the currency acceptor 106.

In one embodiment, as illustrated in FIG. 4, the currency acceptor 106 is associated with a currency acceptor carriage 400. The carriage 400 supports the currency acceptor 106, including the currency container.

In a preferred embodiment, the currency acceptor carriage 400 is configured as a support structure or frame. As illustrated, the carriage 400 has a pair of outer walls (only one of which is visible in FIG. 4). The carriage 400 generally defines an interior space in which the currency acceptor 106 is located. In one embodiment, the carriage 400 includes a currency container security door or panel 402 for selectively controlling access to a portion of the interior area of the carriage 400. The panel 402 is mounted for movement relative to the remainder of the carriage 400, so that it may move between a closed position (in which it generally blocks access to a currency container located there behind, as detailed below) and an open position. As illustrated, the panel 402 is mounted to one of the walls of the carriage 400 with one or more hinges, thereby allowing the panel 402 to rotate relative to the carriage 400. As also illustrated, the panel 402 may be lockable, such as with a key-actuated lock 404, so that access to a currency storage area is further restricted according to the gaming establishment's preferences.

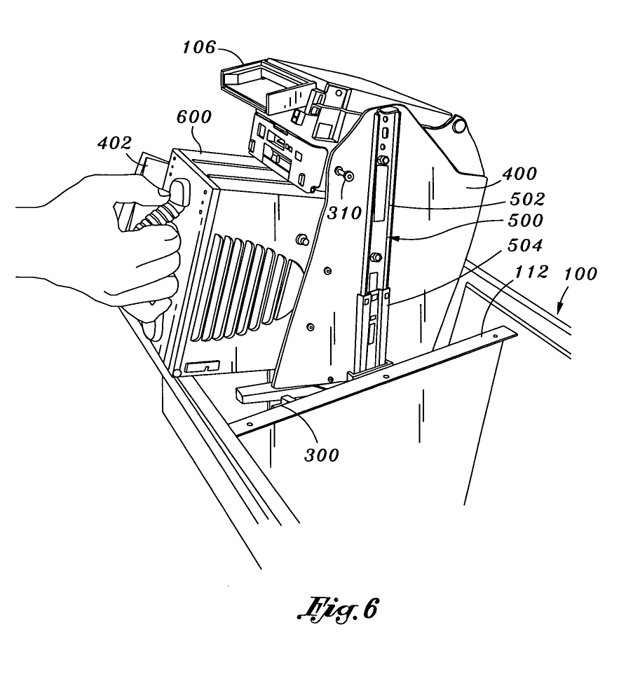

In order to facilitate the above-described movement of the currency acceptor 106, the carriage 400 is configured for movement relative to the gaming device. Referring to FIG. 5, the carriage 400 is preferably mounted for linear vertical movement relative to the gaming device 100. A moveable mount connects the carriage 400 to the gaming device 100. In one embodiment, the moveable mount comprises a linear transport, preferably comprising a pair of slides 500.

In a preferred embodiment, each slide 500 comprises a first slide member 502 fixed or mounted to the carriage 400 and a second slide member 504 fixed or mounted to the cabinet 102 of the gaming device 100. As illustrated, the first and second slide members 502, 504 are elongate supports which are connected in a sliding relationship (they may be supported by one or more bearings or the like to facilitate smooth relative movement). The first and second slide members 502, 504 are aligned along their length-wise axes, and are thus configured to move relative to one another along those axes. In this fashion, the slide members 502, 504 permit linear movement.

As illustrated, the slide 500 is mounted so that the axes of the first and second slide members 502, 504 (and thus the axes along which the two members translate) are oriented vertically (i.e. parallel to the sides, front and back of the cabinet 102 of the gaming device 100, and perpendicular to the bottom and top 104e of the gaming device 100).

In one embodiment, the carriage 400 is biased towards its extended position (as illustrated in FIG. 5). At least one biasing member 506 preferably biases the carriage 400 by exerting a vertical lifting force between the gaming device 100 and the carriage 400. The force is used to raise or to aid in the raising of the carriage 400 from the lower position to an upper position to facilitate access to the currency acceptor 106 and currency container security panel 402. The at least one biasing member 506 maybe one of several known devices such as a gas charged shock, a pneumatically powered actuator, a mechanical spring rail, electro mechanical gear assembly or a electromagnetic solenoid.

In a preferred embodiment, the biasing member 506 is a gas charged shock. In such a configuration, the shock is connected at opposing ends (one end being the body of the shock and the other being an end of the arm which extends therefrom) to brackets 508a,b. A first bracket 508a is mounted to the carriage 400 and the second bracket 508b is mounted to the gaming device 100, so that the biasing member transfers stored energy between the carriage 400 and gaming device 100 in a substantially vertical direction. The stored energy may be imparted into the biasing member 506 when the carriage 400 is returned to the lower position within the gaming device 100.

When the carriage 400 is configured so that it is biased upwardly towards its extended or upper position, the carriage 400 is configured to be selectively retained in its retracted or lower position. In one embodiment, as best illustrated in FIGS. 3 and 5, a latch mechanism 300 is configured to selectively retain the carriage 400 in its lower or retracted position (against the upward biasing force generated by the biasing member). The latch mechanism 300 has a pivotal arm 302 which is internally mounted within the gaming device 100 and configured to selectively engage the carriage 400. When the arm 302 engages the carriage 400, it preferably prevents upward movement of the carriage 400. When released from the carriage 400, the carriage 400 is permitted to move upwardly to the position illustrated in FIG. 5.

Referring to FIGS. 3 and 5, in one embodiment, the pivotal arm 302 is generally “L”-shaped, having a first end 306, a second end 308, and a notch or detent there between 304. The first end 306 is preferably movably mounted to the cabinet 102 of the gaming device 100. As illustrated, the first end 306 is pivotally mounted about a pin. The arm 302 extends generally vertically upward from its mounting before extending generally vertically outward to the second end 308. The second end 308 preferably defines a user-engaging surface.

The notch or detent 304 of the arm 302 is located between the first and second ends 306,308 thereof. The detent 304 is configured to selectively engage a mating boss 310 (see FIG. 3) located on the carriage 400. Preferably, when the arm 302 is in the position illustrated in FIG. 5 (where it is engaging the boss), upward movement of the carriage 400 is prevented. On the other hand, when the latch mechanism 300 is de-activated, by pressing downwardly on the second end 308 thereof (as illustrated in FIG. 3), the boss and detent move out of engagement with one another. At that time, the carriage 400 is free to move upwardly.

Referring now to FIG. 6, when the carriage 400 is in its upper position, a currency container 600 of the currency acceptor 106 becomes accessible. In particular, when the carriage 400 reaches its upper position, the currency container security door or panel 402 can be unlocked and opened. The currency container 600 which is located in the carriage 400 can then be accessed. As illustrated, the currency container 600 can be pulled generally horizontally out of the carriage 400 towards the front of the gaming device 100. In this manner, a full currency container may be exchanged with a substantially empty container (generally, a full currency container is exchanged with an empty container to ensure and facilitate proper accounting of currency such that while containers may be exchanged at any time (whether full, empty or partially full), a full container is generally exchanged with an empty one).

Use of the currency acceptor transport mechanism will now be described in greater detail. Referring to FIG. 1, during normal use of the gaming device 100, the currency acceptor 106 is located inside the cabinet 102 of the gaming device. In particular, the currency acceptor 106 is in a retracted position in which it is located under a currency acceptor access panel 108. The currency acceptor 106 is primarily maintained in its retracted position by the latch mechanism. However, even if the latch mechanism failed, the access panel 108 would prevent movement of the currency acceptor 106.

In this position, a user may insert currency into a currency accepting slot 107 of the currency acceptor 106 through a correspondingly aligned slot in the access panel 108. Accepted currency may be credited by the gaming device 100 for placement of one or more wagers by the player. For example, the currency acceptor 106 may provide one or more signals regarding accepted currency to a processing unit of the gaming device 100, which processing unit indicates credits available for play by the player.

In the event the currency acceptor 106 requires servicing, it can conveniently be raised vertically for access. Referring to FIGS. 2 and 6, appropriate personnel may unlock the access panel 108 and move it out of the path of the carriage 400. Once the panel 108 is opened, an access opening is revealed or accessible, thus providing access to an interior portion of the gaming device through the top thereof. Once open, the latch mechanism 300 is accessible, as illustrated in FIG. 3. Once the pivot arm 302 is depressed, the carriage 400 is disengaged. At that time, referring to FIGS. 5, the biasing member 506 raises the carriage 400 vertically out of the gaming device 100. As illustrated in FIG. 6, in its raised position, at least a portion of the carriage 400 is preferably exterior to and thus above the top of the gaming device 100.

Once the carriage 400 is raised, various of the components of the currency acceptor 106 may be accessed. For example, the read head or other components of the currency reader/acceptor portion of the acceptor 106 may be accessed for repair or replacement. Further, as illustrated in FIG. 6, the currency container security panel 402 may be unlocked and opened, thus permitting access to the currency container 600.

Once desired access to the currency acceptor 106 is completed, a user may press downwardly upon the carriage 400 to move it back to its retracted position. Once the carriage 400 reaches its retracted position, the boss thereon engages the detent of the pivot arm 302, so that the latch mechanism 300 retains the carriage 400 in the retracted position.

It will be appreciated that the currency device transport mechanism of the invention may have a variety of configurations. In one embodiment, as described, the biasing member(s) comprise gas or similar shocks. The biasing member(s) may comprise other devices, such as a direct gear drive. This embodiment may provide a plurality of gears that are driven by an electrical motor. The gears are arranged such that a substantially vertical lifting force is imparted between the gaming device and the transport carriage. The force is preferably sufficient to overcome the static weight of the transport carriage and currency acceptor assembly and raise the assembly to the upper position. Other biasing members such as springs, stretchable cords or diaphragms may be utilized.

In a preferred embodiment, the biasing member(s) is configured to bias the carriage upwardly. In other embodiments, the biasing member(s) could be configured to bias the carriage towards its retracted position. In yet other embodiments, biasing member(s) may be configured to aid in raising and lowering the carriage. For example, in the case of an electrical drive, the carriage may be raised and lowered by a motor (where the direction the motor output shaft turns dictates whether the carriage is raised or lowered).

Other types of latch mechanisms may also be utilized. For example, the latch mechanism may be electronically controlled, such as with a solenoid or motor.

The carriage may be permitted to move upwardly and downwardly by other than a slide. For example, the carriage may have one or more wheels mounted thereon which can move along a track which is associated with the gaming device cabinet. In one embodiment, the slide(s) and biasing member(s) maybe combined. For example, the carriage might be connected to a pair of linear actuating biasing pistons, the arms of which move linearly in and out.

The invention has a number of advantages. Most importantly, the configuration of the gaming device provides access to a currency acceptor (including associated currency container) without the gaming device having a front access door and the bar-top or other mount having an associated opening which permits that door to be opened. To the contrary, the gaming device can be mounted so that the cabinet is entirely enclosed within the bar-top.

In addition, the currency container can be accessed through a sub-panel at the top of the gaming device. Consequently, the technician can perform a currency collection procedure without having to open a substantial portion of the gaming device, and thus the major internal components of the gaming device are less vulnerable.

Another advantage over previous gaming device configurations is that a technician may access the currency container while standing by the gaming device. Correspondingly, the technician does not have to bend down under the gaming device, negotiate around fixed obstacles, such as bar stools, and in this way the technician will experience less fatigue. As a result, the technician may perform more collections in a shorter amount of time and is thus more efficient.

Still another advantage, is that the technician has mechanical assistance in raising the currency acceptor to the upper access position. Thus, the technician will experience less physical exertion and may perform more collections per working shift.

Although the above provides a full and complete disclosure of the preferred embodiments of the invention, various modifications, alternate constructions and equivalents will occur to those skilled in the art.

It will be understood that the above described arrangements of apparatus and the method there from are merely illustrative of applications of the principles of this invention and many other embodiments and modifications maybe made without departing from the spirit and scope of the invention. Therefore, the above should not be construed as limiting the invention as defined in the claims.

What is claimed is:

1. A table-top gaming device comprising:
a gaming cabinet having a generally planar top having an interior space thereunder;
a currency acceptor access panel located at said top of said gaming cabinet, said currency acceptor access panel configured to move between an open position and a closed position, said panel in said open position defining an access opening into said gaming cabinet;
a currency acceptor carriage;
at least one linear transport having a first portion connected to said gaming cabinet and a second portion connected to said carriage, said at least one linear transport oriented so that said first and second portions may move relative to one another along a substantially vertical path, whereby said carriage connected thereto may be moved between a retracted position in which it is located in said interior space of said gaming cabinet and a raised position in which at least a portion thereof extends through said access opening when said currency acceptor panel is in its open position;
at least one biasing member operatively connected to said carriage, said biasing member applying a biasing force tending to raise said carriage to said raised position; and
a latch mechanism movable between a latched position in which it engages said carriage and maintains said carriage in said retracted position and a released position in which said carriage is permitted to move upwardly to its raised position.

2. The table-top gaming device of claim 1, further comprising a currency acceptor mounted within said carriage for vertical displacement in conjunction with said carriage.

3. The table-top gaming device of claim 1, wherein the access panel is securely lockable with the gaming cabinet.

4. The table-top gaming device of claim 1, wherein an additional linear transport is operatively attached between a side on said carriage and adjacent an interior portion of said gaming cabinet.

5. The table-top gaming device of claim 1, wherein the biasing member is a gas charged telescoping shock.

6. The table-top gaming device of claim 1, wherein the currency acceptor further includes a currency container located below the currency acceptor, where the currency container stores currency therein.

7. The table-top gaming device of claim 1, wherein the latch mechanism is electro-mechanically actuated.

8. The table-top gaming device of claim 1, wherein said carriage further includes a currency security panel for securely retaining a currency container located therein.

9. A method for accessing a currency container located within a table-top gaming device, the method comprising:
unlocking and opening a currency acceptor access panel;
actuating a latch mechanism located beneath the access panel, wherein by actuating the latch mechanism a carriage containing a currency acceptor and a currency container is raised substantially vertically, to a raised position above a top surface of the gaming device;
removing the currency container from the carriage and currency acceptor assembly;
installing a substantially empty currency container within the carriage and currency acceptor assembly;
lowering the carriage to a retracted position within the gaming device; and
closing and locking the currency acceptor access panel.

10. The method of claim 9, wherein the carriage is raised to an upper position by a biasing member.

11. The method of claim 10, wherein the biasing member is a gas charged shock.

12. The method of claim 10, wherein the biasing member is driven by an electronic motor.

13. The method of claim 9, wherein the currency container is located beneath the currency acceptor and both are located within the carriage.

14. The method of claim 9, wherein the step of actuating the latch mechanism further comprises actuation of an electro-mechanical switch.

15. The method of claim 9, wherein the step of removing the currency container requires unlocking and opening a currency container security panel.

16. A method of fabricating a table-top gaming device with a vertically accessible currency acceptor, the method comprising:
providing a gaming cabinet having a generally planar top having an interior space thereunder;
providing a currency acceptor access panel located atop said gaming cabinet;
configuring a currency acceptor carriage disposed beneath said access panel, located within said cabinet, and substantially vertically movable with respect to said cabinet;
installing at least one linear transport operatively attached between a side on said carriage and adjacent an interior portion of said gaming cabinet;
installing at least one biasing member operatively attached between said carriage and adjacent to said interior portion of said gaming cabinet for raising said carriage to a substantially vertical upper position above a top surface of the gaming device; and
providing a latch mechanism located within said gaming cabinet, said latch mechanism operatively arranged to releasably retain the carriage in a retracted position within the gaming device.

17. The method of claim 16, wherein the step of providing a currency acceptor access panel further includes a provision for a locking the access panel in a closed position.

18. The method of claim 16, wherein the step of installing a biasing member further includes an electro-mechanical biasing member.

19. The method of claim 16, wherein the step of configuring the carriage further includes a currency acceptor and a currency container assembled therein.

20. The method of claim 19, further including the currency container located beneath the currency acceptor.
